(19) United States
(12) Patent Application Publication
(10) Pub. No.: US 2010/0020992 A1
(43) Pub. Date: Jan. 28, 2010

(54) HEARING AID WITH MEMORY SPACE FOR FUNCTIONAL SETTINGS AND LEARNED SETTINGS, AND PROGRAMMING METHOD THEREOF

(75) Inventor: Mark Flynn, Smorum (DK)

Correspondence Address: BIRCH STEWART KOLASCH & BIRCH, PO BOX 747, FALLS CHURCH, VA, 22040-0747, US

(73) Assignee: OTICON A/S, Smorum (DK)

(21) Appl. No.: 12/443,151

(22) PCT Filed: Sep. 27, 2006
(86) PCT No.: PCT/EP06/66788

§ 371 Date: Mar. 26, 2009

(51) Int. Cl. H04R 25/00

(52) U.S. Cl. 381/314; 381/330

(57) ABSTRACT

The invention provides a hearing aid comprising a microphone, a signal processing unit, an output unit which generates an output signal perceivable as sound, whereby the signal processing unit comprises a first memory M1 for receiving and storing programming settings which determines the functionality of an amplifier and analyser within the signal processing unit and a second memory for receiving and storing learned settings from the analyser, which determine further aspects of the functionality of the analyser and amplifier unit whereby a programming interface is provided having a read and write line to the first memory M1 and a read and write line to the second memory M2.

### AREA OF THE INVENTION

The invention relates to the area of hearing aids and programming thereof, especially hearing aids which have a capacity for learning during use.

### BACKGROUND OF THE INVENTION

Many modern hearing aids will take relevant data from a previous fitting when a new hearing aid is to be used by a user who upgrades or renews his hearing aid. This allows settings relating to personal preferences of the user and settings necessitated by the hearing loss of the user to be taken from one hearing aid and used in the fitting of another for the same user. For instance, if a user has a hearing aid with vivid settings of various parameters it is most likely that this will also provide the best initial acceptance in his next hearing aid. Therefore, the previous settings should be indicated or prescribed as default in the next hearing aid. In newly developed hearing aids a certain learning function is often implemented, such that during use settings such as volume setting and program choice performed by the user are gradually learned by the hearing aid. In this way a hearing aid which has been worn for some time will function in a markedly different way compared to a hearing aid which is brand new, or has been used by another user. This is a problem whenever a hearing aid user up-grades to a newer version of a hearing aid or changes from one hearing aid style to another.

### SUMMARY OF THE INVENTION

The invention provides a hearing aid comprising a microphone, a signal processing unit, an output unit which generates an output signal perceivable as sound, whereby the signal processing unit comprises a first memory M1 for receiving and storing programming settings which determines the functionality of an amplifier and analyser within the signal processing unit and a second memory for receiving and storing learned settings from the analyser, which determine further aspects of the functionality of the analyser and amplifier unit whereby a programming interface is provided having a read and write line to the first memory M1 and a read and write line to the second memory M2.

By means of the suggested hearing aid, learned settings in the second memory M2 are transferable to another hearing aid. Hereby the user will not have to “reprogram” the new hearing aid by using it in different environments but the settings already learned by the old hearing aid will be available immediately when the new hearing aid is used. Also the data relating to learned settings when available during the fitting session may aid to ensure an even better fit with better adjustments according to the wishes of the user.

In an embodiment of the invention the first and the second memory (M1,M2) share the same memory space. There need not be a difference in the nature of the data dependent on whether they are loaded onto the hearing aid in a programming session or whether they are learned during use of the hearing aid. Thus memories M1 and M2 may comprise data spaces with the same format, and only the addresses used in the memory space will allow the fitting computer to distinguish between them.

Further the invention comprises a method for programming a hearing aid whereby
programming settings in a first memory M1 within a first hearing aid are transferred and uploaded onto a first memory of a second hearing aid 1a,
learned settings in a second memory M2 within the first hearing aid are transferred from the first hearing aid and uploaded onto the second memory M2 of the second hearing aid.

When this method is used it will be possible for a new hearing aid to inherit the settings, which has been learned by the old hearing aid. A new and prolonged learning period can be avoided in this way. This can also happen between different models and generations, i.e. when the hearing aid user comes back in for a new hearing aid in three years time, all of the data that it has collected is available for the fitting of the new one

In a further embodiment of this invention, learned settings from an ITE (in the ear hearing aid) should be made available if the user changes to a BTE (behind the ear hearing aid) or vice versa. Therefore, learning is not lost when styles are changed. Also the audiologist can send the user out with a BTE for a month, have it learn the users preferred settings of the volume control in different sound environments, and then load the learned settings over to an ITE. Here the advantage is that the BTE hearing aid has a volume control whereas the ITE does not, but programmed with the learned settings it will appear as if it has a volume control.

The programming settings and the learned settings are initially transferred from the first hearing aid to a programming device outside the first hearing aid and from here uploaded onto the first and second memory (M1, M2) of the second hearing aid. This allows the data to be stored for a lengthy time, and also re-use of the learned data in more than one hearing aid becomes possible. The data may then not be simply transferred but may also be available to the fitting software for a better fitting.

In an embodiment of the invention the programming settings and/or learned settings from the first hearing aid are formatted and/or scaled to fit into the second hearing aid. Data formats may be different in different brands of hearing aids, and by changing format, data retrieved from one hearing aid brand may be re-used in another brand.

In a further embodiment, supplemental programming settings are added and loaded onto the second hearing aid during programming. The need for such supplemental programming settings may arise if the new hearing aid chosen by the user has functionality features, which are not present in the old hearing aid. Then it becomes necessary to add programming settings which controls the new functionality features.

### BRIEF DESCRIPTION OF THE DRAWINGS

FIG. 1 shows a diagram of a hearing aid according to the invention,

FIG. 2 shows a diagram of two hearing aids and a fitting device according to the invention.

### DESCRIPTION OF A PREFERRED EMBODIMENT

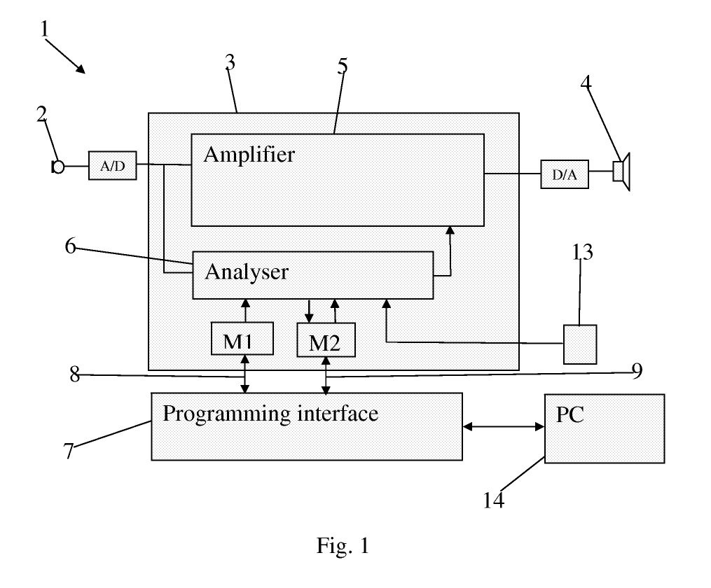

In FIG. 1, a hearing aid 1 according to the invention is shown. The hearing aid 1 comprises a microphone 2, a signal processing unit 3 and an output unit 4. The signal processing unit 3 will in most cases be implemented as a digital processing unit and therefore also analog to digital and digital to analog converters are indicated in FIG. 1 at the respective input and output ends of the processor 3. The output unit 4 may be a simple loudspeaker, piping sound into the ear of the user of the hearing aid 1, or it could be an implanted electrode or bone conductor device designed to provide a sensation of sound to the user.

The signal processor comprises an amplifier 5, an analyser 6 and memory spaces M1 and M2. The amplifier 5 provides amplification according to the specific needs of the user, and in accordance with the input from the microphone 2. Thus the input signal is served at the analyser 6, and from the memory M1 the right parameters for the amplifier are chosen. In this way directionality, noise damping, compression release and attack times and various other processing options of the amplifier are controlled.

During use, volume setting and programme choice performed by the user are input to the hearing aid 1 through user input interface 13. The interface 13 could be a volume wheel or a push button on the hearing aid or it could be remote control (not shown). The analyser 6 takes such input into account when the amplifier 5 is controlled. Through the users repeated use of input interface 13 the hearing aid 1 may by and by learn under which circumstances a certain setting is whished, and then on its own account choose this setting. In memory M2 the parameters, called learned settings, will be stored, which guides these automatic settings learned through the users choice of settings.

A programming interface 7 and a computer 14 are also indicated in the embodiment of FIG. 1. As indicated the computer 14 may be a usual PC, but other computer devices with input and output means as well as data processing and storing means may be used. The programming interface 7 is part of the hearing aid 1. Connection lines 8 and 9 connect the two memory spaces M1 and M2 respectively such that the settings stored in these memory spaces may be downloaded and/or uploaded to/from the computer 14 through programming interface 7. In this embodiment the programming computer 14 is directly connected to the programming interface 7 of the hearing aid, but in some cases a separate interface between computer and hearing aid interface 7 will be provided depending on the programming system used. The connections between programming interface 7 and computer 14 and may be wired or wireless.

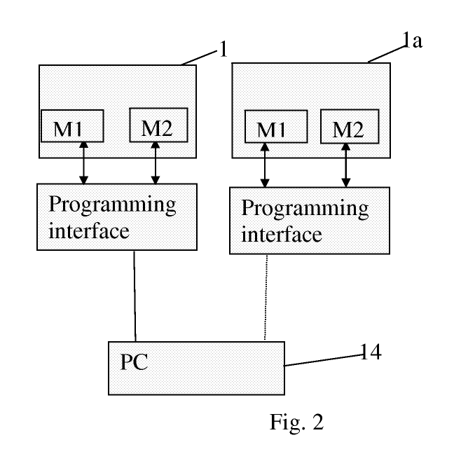

In FIG. 2 a first hearing aid 1 is connected to programming computer 14, and during an off-load operation the memory contents of M1 and M2 are downloaded to the programming computer 14. This is in the event that the hearing aid 1 is not to be used by this user any more. At the same time, or at a later time a further hearing aid 1a is connected to the programming computer 14. This further hearing aid 1a is to be used by the user in lieu of the first hearing aid 1. Provided memory spaces M1 and M2 are available in the further hearing aid 1a, the data from hearing aid 1 may be uploaded to the further hearing aid 1a. Now further hearing aid 1a has the same functionality as hearing aid 1 and the user may wear hearing aid 1a and from day one benefit from the learning performed with the first hearing aid 1.

If the first hearing aid 1 and the further hearing aid 1a are not exactly alike, the data defining the settings in the two instruments may not have like formats, and it may then be necessary to perform a format change in the programming unit 12. Further, some parameters may be added in the programming device, in the event that the further hearing aid, which in many cases will be an upgrade, comprise a wider range of programmable parameters.

1. Hearing aid comprising a microphone (2), a signal processing unit (3), an output unit (4) which generates an output signal perceivable as sound, whereby the signal processing unit (3) comprises a first memory (M1) for receiving and storing programming settings which determines the functionality of an amplifier (5) and analyser (6) within the signal processing unit (3) and a second memory (M2) for receiving and storing learned settings from the analyser (6), which determine further aspects of the functionality of the analyser (6) and amplifier (5) whereby a programming interface (7) is provided having a read and write line (8) to the first memory (M1) and a read and write line (9) to the second memory (M2).

2. Hearing aid as claimed in claim 1, wherein the first and the second memory (M1,M2) share the same memory space.

3. Method for programming a hearing aid whereby
programming settings in a first memory (M1) within a first hearing aid (1) are transferred and uploaded onto a first memory of a second hearing aid (1a),
learned settings in a second memory (M2) within the first hearing aid (1) are transferred from the first hearing aid (1) and uploaded onto the second memory (M2) of the second hearing aid (1a).

4. Method as claimed in claim 1 wherein the first hearing aid is a BTE hearing aid and the second hearing aid is an ITE hearing aid or vice versa.

5. Method for programming a hearing aid as claimed in claim 3, whereby the programming settings and the learned settings are initially transferred from the first hearing aid (1) to a programming computer (14) outside the first hearing aid (1) and from here uploaded onto the first and second memory (M1, M2) of the second hearing aid (1a).

6. Method for programming a hearing aid as claimed in claim 3, whereby the programming settings and/or learned settings from the first hearing aid (1) are formatted and/or scaled to fit into the second hearing aid (1a).

7. Method for programming a hearing aid as claimed in claim 4, whereby supplemental programming settings are added and loaded onto the second hearing aid (1a) during programming.
